(19) United States
(12) Patent Application Publication
(10) Pub. No.: US 2022/0223892 A1
(43) Pub. Date: Jul. 14, 2022

(54) FUEL CELL SYSTEM

(71) Applicants: FUJI ELECTRIC CO., LTD., Kawasaki-shi (JP); MITSUBISHI POWER, LTD., Yokohama-shi (JP)

(72) Inventor: Kuniyuki TAKAHASHI, Kawasaki-shi (JP)

(73) Assignees: FUJI ELECTRIC CO., LTD., Kawasaki-shi (JP); MITSUBISHI POWER, LTD., Yokohama-shi (JP)

(21) Appl. No.: 17/709,538

(22) Filed: Mar. 31, 2022

Related U.S. Application Data
(63) Continuation of application No. PCT/JP2020/044498, filed on Nov. 30, 2020.

(30) Foreign Application Priority Data
Dec. 25, 2019 (JP) 2019-234464

(51) Int. Cl. H01M 8/0612; H01M 8/04089; H01M 8/04082; H01M 8/04664; H01M 8/04746

(52) U.S. Cl. CPC H01M 8/0618; H01M 8/04089; H01M 2008/1293; H01M 8/04671; H01M 8/04753; H01M 8/04201

(57) ABSTRACT

Provided is a fuel cell system that can prevent oxidation degradation of a fuel electrode, even in the case where a control unit stops abnormally. A fuel cell system (1) comprises an SOFC (10) that generates electricity through an electrochemical reaction between a reduction gas and an oxidant gas, a control unit (40) that controls the supply of the reduction gas and the oxidant gas to the SOFC, a detection unit (45) that detects a stopping of a normal signal of the control unit or detects an abnormal signal of the control unit transmitted from the control unit, and a maintenance unit (50) that keeps a fuel electrode of the SOFC in a reduced state according to a detection result from the detection unit. The maintenance unit includes a hydrogen supply system (51) that supplies hydrogen to the fuel electrode as the reduction gas.

### CROSS REFERENCE TO RELATED APPLICATIONS

This is a continuation application of International Application PCT/JP2020/044498 filed on Nov. 30, 2020 which claims priority from a Japanese Patent Application No. 2019-234464 filed on Dec. 25, 2019, the contents of which are incorporated herein by reference.

### BACKGROUND OF THE INVENTION

### Technical Field

The present invention relates to a fuel cell system.

### Background Art

Recently, the development of solid oxide fuel cells (SOFCs) is progressing. An SOFC is a power generation mechanism in which electrical energy is generated by causing oxide ions generated by an air electrode to pass through an electrolyte and move to a fuel electrode, such that the oxide ions react with hydrogen or carbon monoxide at the fuel electrode. SOFCs have the characteristics of having the highest operating temperatures for power generation (for example, from 600° C. to 1000° C.) and also the highest power-generating efficiency among currently known classes of fuel cells.

Patent Literature 1 discloses a fuel cell system provided with a detection means that detects a state in which a fuel is no longer supplied to an SOFC and an emergency stopping means that executes an emergency stop of the SOFC according to a detection result from the detection means. The fuel cell system is further provided with a control means that performs a protection operation of stopping the supply of the fuel and an oxidant on the condition that the detection means no longer detects the fuel, and supplying an inert gas to the SOFC.

Patent Literature 2 discloses a power generation system provided with a vent line that branches off from a waste fuel gas line carrying a waste fuel gas from the SOFC, a shutoff valve and an orifice provided in the vent line, and a measurement means that measures and outputs the system differential pressure of the SOFC to a control device. In the power generation system, in the case where a failure occurs in the control device, the systems for supplying and discharging a fuel gas and an oxidant gas are shut off, and the shutoff valve, the orifice, and the like are controlled such that the differential pressure measured by the measurement means reaches a predetermined value.

### CITATION LIST

### Patent Literature

Patent Literature 1: Japanese Patent Laid-Open No. 2006-66244

Patent Literature 2: Japanese Patent Laid-Open No. 2016-91644

### SUMMARY OF INVENTION

### Technical Problem

However, in Patent Literature 1, when the control means stops, the supply of the fuel and the oxidant can no longer be controlled, and moreover the protection operation can no longer be controlled. For this reason, there is a problem in that the fuel electrode can no longer be kept in a reduced state and the fuel electrode is degraded by oxidation.

Also, Patent Literature 2 merely maintains the system differential pressure (the differential pressure between the fuel electrode and the air electrode) and does not keep the fuel electrode in a reduced state when a failure occurs in the control device, and consequently there is a problem in that the fuel electrode is degraded by oxidation similarly in Patent Literature 2, too.

An object of the present invention, which has been made in the light of such points, is to provide a fuel cell system that can prevent oxidation degradation of the fuel electrode, even in the case where a control unit stops abnormally.

### Solution to Problem

In one aspect, a fuel cell system according to the embodiments comprises a solid oxide fuel cell including an electrolyte interposed between a fuel electrode supplied with a reduction gas and an air electrode supplied with an oxidant gas, the solid oxide fuel cell generating electricity through an electrochemical reaction between the reduction gas and the oxidant gas, a control unit that controls the supply of the reduction gas and the oxidant gas to the solid oxide fuel cell, a detection unit that detects a stopping of a normal signal of the control unit and/or detects an abnormal signal of the control unit transmitted from the control unit, and a maintenance unit that keeps the fuel electrode in a reduced state according to a detection result from the detection unit.

### Advantageous Effects of Invention

According to the present invention, the fuel electrode can be kept in a reduced state by the maintenance unit on the condition that the control unit transmits an abnormal signal or becomes incapable of transmitting a normal signal. With this arrangement, the degradation of the fuel electrode by oxidation at high temperatures can be prevented.

### BRIEF DESCRIPTION OF DRAWINGS

FIG. 1 is a block diagram illustrating a fuel cell system according to a first embodiment.

FIG. 2 is a time chart for explaining operations during an abnormal stop of the fuel cell system.

FIG. 3 is a block diagram illustrating a fuel cell system according to a second embodiment.

FIG. 4 is a block diagram illustrating a fuel cell system according to a third embodiment.

### DESCRIPTION OF EMBODIMENTS

### First Embodiment

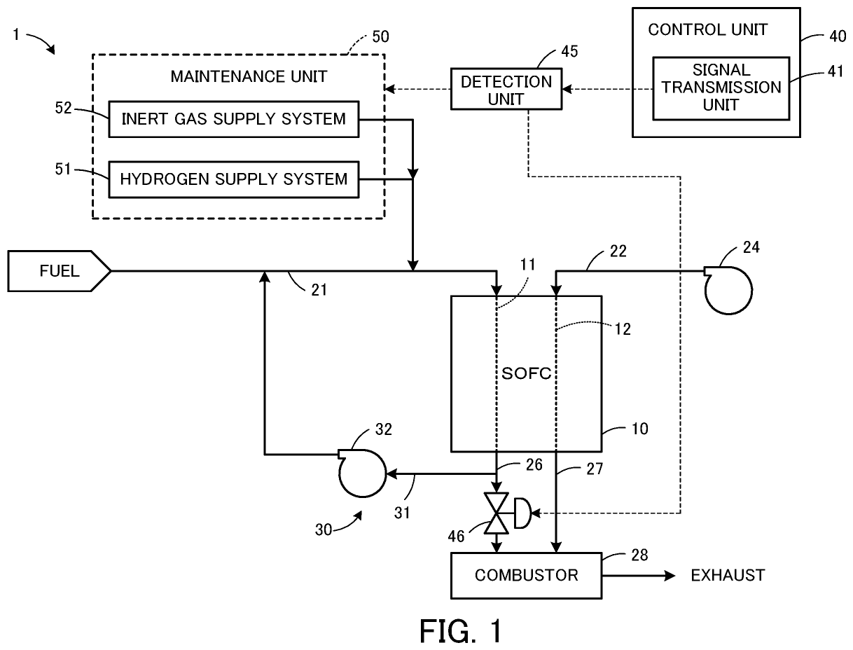

FIG. 1 will be referenced to describe a fuel cell system according to a first embodiment in detail. FIG. 1 is a block diagram illustrating the fuel cell system according to the first embodiment.

As illustrated in FIG. 1, a fuel cell system 1 includes a solid oxide fuel cell (SOFC) 10. The SOFC 10 includes a cell stack configured as a layering or a collection of a plurality of cells. Each cell has a basic configuration in which an electrolyte is disposed between an air electrode and a fuel electrode (none of which is illustrated), and a separator is interposed between the cells. The cells of the cell stacks are electrically connected in series. The SOFC 10 is a power generation mechanism in which electrical energy is generated by causing oxide ions generated by an air electrode to pass through an electrolyte and move to a fuel electrode, such that the oxide ions react with hydrogen or carbon monoxide at the fuel electrode.

The SOFC 10 includes an anode gas flow channel (fuel gas flow channel, reduction gas flow channel) 11 that supplies a fuel gas (reduction gas) to the fuel electrode and a cathode gas flow channel (oxidant gas flow channel) 12 that supplies an oxidant gas to the air electrode. For the fuel gas, a gas containing a hydrocarbon-based fuel, such as city gas (methane gas), natural gas, or biogas such as digestion gas is used. Atmospheric air is one example of the oxidant gas.

The fuel cell system 1 is provided with an anode gas supply channel 21 connected to an inlet of the anode gas flow channel 11, and a cathode gas supply channel 22 connected to an inlet of the cathode gas flow channel 12. When the SOFC 10 generates electricity, the fuel gas is supplied to the anode gas flow channel 11 through the anode gas supply channel 21, and the fuel gas flows through the anode gas flow channel 11. Also, the oxidant gas is supplied to the cathode gas flow channel 12 through the cathode gas supply channel 22, and the oxidant gas flows through the cathode gas flow channel 12. By inducing an electrochemical reaction between the fuel gas (reduction gas) supplied to the anode gas flow channel 11 and the oxidant gas supplied to the cathode gas flow channel 12, a direct current is produced (the SOFC 10 generates electricity). The direct current generated by the SOFC 10 is converted in an alternating current (DC/AC converted) by an inverter (not illustrated).

A reaction air blower 24 is provided in the cathode gas supply channel 22. The cathode gas supply channel 22 supplies atmospheric air brought in by the reaction air blower 24 to the cathode gas flow channel 12 as the oxidant gas.

The fuel cell system 1 is provided with an anode gas discharge channel 26 connected to an outlet of the anode gas flow channel 11, and a cathode gas discharge channel 27 connected to an outlet of the cathode gas flow channel 12. In addition, the fuel cell system 1 is provided with a combustor 28 connected to the anode gas discharge channel 26 and the cathode gas discharge channel 27. The anode gas discharge channel 26 discharges an exhaust gas from the outlet of the anode gas flow channel 11 to the combustor 28, and the cathode gas discharge channel 27 discharges an exhaust gas from the outlet of the cathode gas flow channel 12 to the combustor 28. The combustor 28 burns the exhaust gases discharged from the SOFC 10 to remove impurities from the exhaust gases, and then exhausts the combusted gas.

The fuel cell system 1 is provided with a recirculation channel 31 that branches off from the anode gas discharge channel 26. The recirculation channel 31 recirculates the exhaust gas from the outlet of the anode gas flow channel 11 to the anode gas supply channel 21 from the anode gas discharge channel 26. The recirculation channel 31 is provided with a recirculation blower 32 that sends the exhaust gas into the recirculation channel 31. Here, the recirculation channel 31 and the recirculation blower 32 form a recirculation system 30 that recirculates the exhaust gas to the anode gas supply channel 21.

The fuel cell system 1 includes a control unit 40 that centrally controls the driving of the components of the fuel cell system 1. More specifically, the control unit 40 is connected to a control valve of the anode gas supply channel 21 not illustrated, the reaction air blower 24, and the recirculation blower 32, and executes a driving control, an on/off control, or an open/close control of these components while the SOFC 10 is in operation. Through the control of the above adjustment valve, reaction air blower 24, and the like by the control unit 40, the supply of the fuel gas (reduction gas) and the oxidant gas is controlled. For example, the fuel cell system 1 includes a personal computer (PC) or a programmable logic controller (PLC), and the PC or the PLC can be the control unit 40, i.e., can perform the functions of the control unit 40. More specifically, the fuel system 1 or the control unit 40 may include a computing device (e.g., a central processing unit (CPU), or a processor) and a memory (storage medium) that stores program instructions. The computing device executes the program instructions to provide the functions of the control unit 40.

In the fuel cell system 1, it is necessary to anticipate the case where the control unit 40 stops abnormally because the supply of power to the control unit 40 is cut off or the control unit 40 itself malfunctions due to unforeseen circumstances during power generation. In this case, in the SOFC 10 in a high-temperature state, the oxide ions generated at the air electrode and passing through the electrolyte cause the fuel electrode to oxidize and become degraded. Accordingly, the fuel cell system 1 according to the present embodiment is provided with the configuration described hereinafter to keep the fuel electrode in a reduced state and suppress oxidation degradation, even in the case where the control unit 40 stops abnormally.

The fuel cell system 1 according to the present embodiment includes a signal transmission unit 41 provided in the control unit 40, a detection unit 45 that detects a signal transmitted by the signal transmission unit 41, and a maintenance unit 50 that operates according to a detection result from the detection unit 45. Similar to the control unit 40, the CPU can execute instructions stored in the memory to perform the functions of the detection unit 45 and the maintenance unit 50. Additionally, the fuel cell system 1 includes a solenoid valve (valve) 46 provided on the downstream side of the branch point of the recirculation channel 31 in the anode gas discharge channel 26. Here, the control unit 40, the detection unit 45, the maintenance unit 50, and the solenoid valve 46 are supplied with power through an uninterruptible power supply (UPS) not illustrated to ensure operations for a certain time even in the case where the supply of power to the fuel cell system 1 as a whole is stopped.

The signal transmission unit 41 is provided with a function that switches the transmission of a signal to the detection unit 45 between a case where an abnormality has occurred in which the components described above cannot be controlled normally due to the control unit 40 itself or an external factor such as a cutoff of the supplied power, and a normal case where the above abnormality has not occurred. For example, a configuration is adopted such that the signal transmission unit 41 transmits a normal signal to the detection unit 45 intermittently or continuously only in the normal case, and transmits an abnormal signal to the detection unit 45 only in the case where an abnormality has occurred.

The detection unit 45 is provided with a function of receiving the normal signal or the abnormal signal transmitted from the signal transmission unit 41. In addition, the detection unit 45 is provided with a function of detecting the state in which the transmission of the normal signal has stopped or detecting the transmission of the abnormal signal, transmitting an actuation signal that actuates the maintenance unit 50 and the solenoid valve 46 on the condition of the above detection, or cutting off an energizing current to the maintenance unit 50 and the solenoid valve 46.

The maintenance unit 50 is provided with a hydrogen supply system 51 that supplies hydrogen gas to the anode gas supply channel 21 as a reduction gas. Examples of the source that supplies the hydrogen gas in the hydrogen supply system 51 include a hydrogen gas cylinder filled with hydrogen gas or a hydrogen supply system in a facility or the like where the fuel cell system 1 is installed. The hydrogen supply system 51 is provided with a solenoid valve for allowing or stopping the supply of the hydrogen gas in the hydrogen gas supply channel. For example, the solenoid valve closes and stops the supply of the hydrogen gas when in an energized state, and opens and allows the supply of the hydrogen gas when in a non-energized state. Consequently, the supply of the hydrogen gas to the anode gas supply channel 21 can be initiated by transmitting an actuation signal from the detection unit 45 to cut off the energizing current or by cutting off the energizing current from the detection unit 45.

The maintenance unit 50 is further provided with an inert gas supply system 52. In the present embodiment, nitrogen gas is adopted as the inert gas, but a gas such as carbon dioxide or steam may also be adopted as the inert gas. Examples of the source that supplies the nitrogen gas in the inert gas supply system 52 include a nitrogen gas cylinder filled with nitrogen gas or a nitrogen supply system in a facility or the like where the fuel cell system 1 is installed. The nitrogen gas supply channel in the inert gas supply system 52 may converge with the hydrogen gas supply channel or may be connected to the anode gas supply channel 21 independently from the hydrogen gas supply channel. The inert gas supply system 52 is provided with a solenoid valve for allowing or stopping the supply of the nitrogen gas in the nitrogen gas supply channel. For example, the solenoid valve closes and stops the supply of the nitrogen gas when in an energized state, and opens and allows the supply of the nitrogen gas when in a non-energized state. Consequently, the supply of the nitrogen gas to the anode gas supply channel 21 can be initiated by transmitting an actuation signal from the detection unit 45 to cut off the energizing current or by cutting off the energizing current from the detection unit 45.

For example, the solenoid valve 46 opens and allows the discharge of the fuel gas from the anode gas discharge channel 26 to the combustor 28 when in an energized state, and closes and stops the discharge of the fuel gas when in a non-energized state. Consequently, the fuel gas can be confined to the anode gas discharge channel 26 and the recirculation channel 31 by transmitting an actuation signal from the detection unit 45 to cut off the energizing current or by cutting off the energizing current from the detection unit 45. In addition, the solenoid valve 46 is provided with a timer or the like for switching from the closed state to the open state after a certain time elapses since the energizing current was cut off, or is provided with a function of switching from the closed state to the open state according to the residual pressure of the hydrogen gas described later.

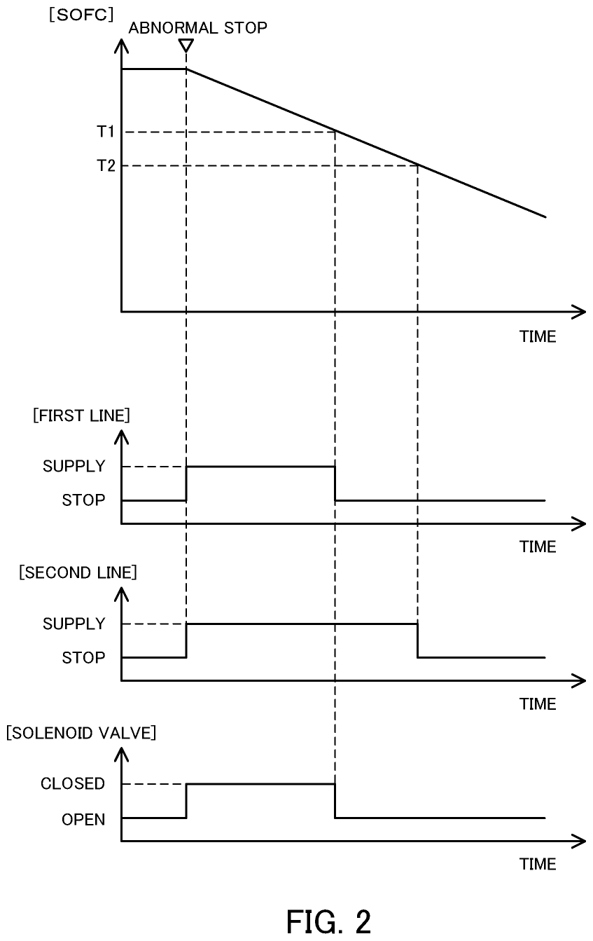

FIG. 2 is a time chart for explaining operations during an abnormal stop of the fuel cell system according to the first embodiment. Hereinafter, FIGS. 1 and 2 will be referenced to describe the operations during an abnormal stop of the fuel cell system 1 in detail.

Here, the case where the supply of power to the fuel cell system 1 as a whole is stopped and the supply of power to the control unit 40 is also stopped due to unforeseen circumstances will be described as the abnormal stop. As illustrated in FIG. 2, a first line and a second line exist as the supply systems of the maintenance unit 50, and in the present embodiment, the first line is taken to be the hydrogen supply system 51, and the second line is taken to be the inert gas supply system 52.

During operations before the abnormal stop, that is, during normal operations, the SOFC 10 is set to a high operating temperature from 600° C. to 1000° C. for example. If the supply of power to the control unit 40 stops in this state, the temperature of the SOFC 10 will fall gradually but still remain in a high-temperature state for some time.

Also, if the supply of power to the control unit 40 stops, the stopping of the transmission of the normal signal, or the transmission of the abnormal signal, from the signal transmission unit 41 is detected by the detection unit 45. On the condition of the above detection, the detection unit 45 transmits an actuation signal to the maintenance unit 50 and the solenoid valve 46, or cuts off the energizing current to the maintenance unit 50 and the solenoid valve 46. With this arrangement, in the maintenance unit 50, the supply of the hydrogen gas in the hydrogen supply system 51 acting as the first line and the supply of the nitrogen gas in the inert gas supply system 52 acting as the second line are started, and the solenoid valve 46 switches from the open state to the closed state.

By supplying hydrogen gas from the hydrogen supply system 51 (first line) and nitrogen gas from the inert gas supply system 52 (second line) through the anode gas supply channel 21, a hydrogen gas of predetermined concentration (reduction gas) is supplied to the anode gas flow channel 11 of the SOFC 10. With this arrangement, the fuel electrode (anode) in the SOFC 10 can be kept in a reduced state, and degradation caused by the oxidation reaction of the fuel electrode can be prevented.

Also, the closing of the solenoid valve 46 makes it possible to regulate the discharge from the anode gas discharge channel 26 of the hydrogen gas of a predetermined concentration supplied from the hydrogen supply system 51 and the inert gas supply system 52, and thereby also contribute to maintaining the reduced state of the fuel electrode. Furthermore, as the temperature falls, the gas contracts in the anode gas flow channel 11, but the closing of the solenoid valve 46 makes it possible to regulate the inflow of air and the like from outside the system into the anode gas flow channel 11 through the anode gas discharge channel 26, and thereby also prevent oxidation degradation of the fuel electrode.

The closing of the solenoid valve 46 causes the hydrogen gas that has passed through the anode gas flow channel 11 to flow into the recirculation channel 31. In other words, the recirculation channel 31 functions as a buffer that stores the hydrogen gas. Additionally, the recirculation channel 31 is also maintained in a high-temperature state during the abnormal stop, and therefore can be used as an evaporation heat source for turning water produced in the SOFC 10 into reforming water.

When the temperature of the SOFC 10 falls to a temperature T1 (from 300° C. to 500° C., such as 400° C. for example) at which the oxidation reaction no longer occurs at the fuel electrode, the supply of the hydrogen gas from the hydrogen supply system 51 (first line) is stopped. The timing of the stop can be set by pre-calculating the cooling time for the SOFC 10 to cool down to the temperature T1 and pre-adjusting the hydrogen gas capacity in the supply source of the hydrogen supply system 51 and the opening degree of a valve for adjusting the quantity of hydrogen gas to be supplied during the cooling period.

Also, at this timing, the supply of the hydrogen gas stops, the residual pressure of the hydrogen gas drops, and the solenoid valve 46 switches from the closed state to the open state according to the operation of the timer in the solenoid valve 46. Furthermore, at the same timing, the supply of the nitrogen gas from the inert gas supply system 52 (second line) is still ongoing. In other words, after the supply of the hydrogen gas from the hydrogen supply system 51 stops, the inert gas supply system 52 can supply the nitrogen gas as an inert gas to the fuel electrode and thereby use the inert gas to purge the hydrogen gas from the fuel electrode. Through the inert gas purge, the hydrogen gas can be discharged outside the system through the open solenoid valve 46 and the anode gas discharge channel 26, safety can be ensured, and safety-related standards can be upheld.

Thereafter, at the timing when the temperature of the SOFC 10 falls to reach a predetermined temperature T2 and the inert gas purge at the fuel electrode is completed, the supply of the nitrogen gas from the inert gas supply system 52 (second line) is stopped. The timing of the stop can be set by pre-calculating the time it takes to complete the inert gas purge and pre-adjusting the nitrogen gas capacity in the supply source of the inert gas supply system 52 and the opening degree of a valve for adjusting the quantity of nitrogen gas to be supplied during this time. With the above, the operations after an abnormal stop of the control unit 40 are completed.

Note that although the above describes the case where the control unit 40 stops abnormally, similar operations preferably are also performed in the case where the uninterruptible power supply described above stops abnormally. With this arrangement, the oxidation degradation of the fuel electrode in the SOFC 10 can also be prevented not only when the control unit 40 fails, but also when the uninterruptible power supply or the like fails.

As above, in the above fuel cell system 1 according to the first embodiment, the hydrogen gas can be supplied to the SOFC 10 as a reduction gas by the hydrogen supply system 51 of the maintenance unit 50, even in the case where the control unit 40 stops abnormally. With this arrangement, the fuel electrode in the SOFC 10 can be kept in a reduced state, and oxidation degradation of the hot fuel electrode can be prevented.

Next, other embodiments of the present invention will be described. Note that the following description uses the same signs to refer to configuration portions which are the same or similar to the embodiment(s) described before the embodiment being described, and a description of such portions will be omitted or simplified.

### Second Embodiment

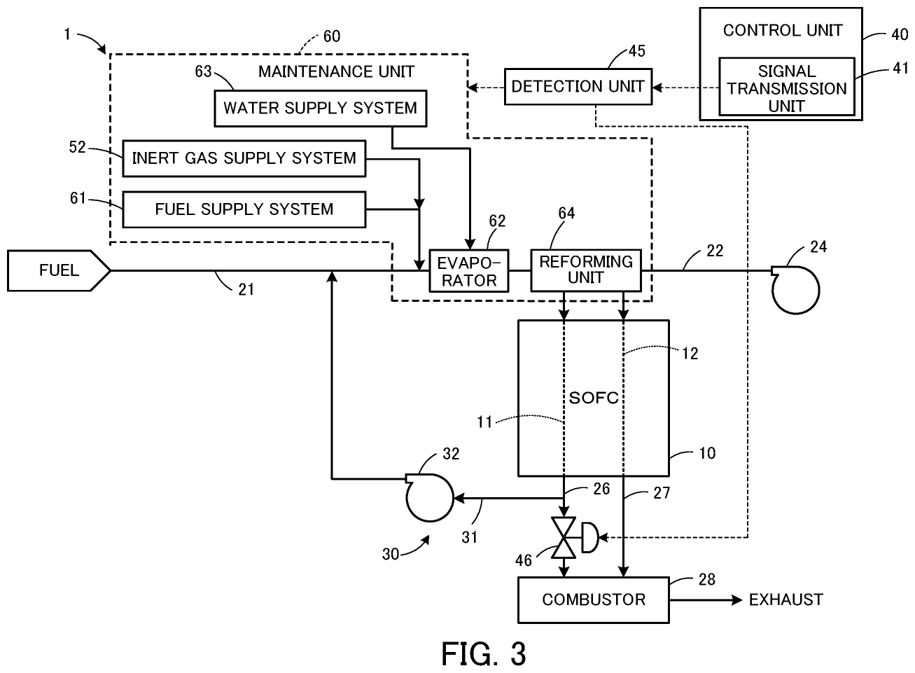

Next, a second embodiment of the present invention will be described with reference to FIG. 3. FIG. 3 is a block diagram illustrating a fuel cell system according to the second embodiment. As illustrated in FIG. 3, in the second embodiment, the configuration of a maintenance unit 60 is changed with respect to the first embodiment.

The maintenance unit 60 according to the second embodiment is provided with a fuel supply system 61 that supplies a fuel gas (hydrocarbon-based fuel) to the anode gas supply channel 21. For example, the fuel supply system 61 may include a gas cylinder filled with a fuel gas such as methane gas as a supply source. The fuel supply system 61 is provided with a solenoid valve for allowing or stopping the supply of the fuel gas in the supply channel, and the solenoid valve works similarly to the solenoid valve in the hydrogen supply system 51 described above.

The maintenance unit 60 is provided with a water supply system 63 that supplies water to an evaporator 62 provided in the anode gas supply channel 21. For example, the water supply system 63 may include a tank storing pure water as a water supply source. The water supply system 63 likewise is provided with a solenoid valve for allowing or stopping the supply of the water in the supply channel, and the solenoid valve works similarly to the solenoid valve in the hydrogen supply system 51 described above.

The maintenance unit 60 is additionally provided with a reforming unit 64. The reforming unit 64 has a function of using steam generated by the evaporator 62 to reform the fuel gas supplied from the fuel supply system 61 into a reduction gas. The reforming unit 64 supplies the reduction gas to the fuel electrode through the anode gas flow channel 11. Although the diagram illustrates the case where the reforming unit 64 is provided in the anode gas supply channel 21 downstream from the evaporator 62, the reforming unit 64 may also be provided inside the SOFC 10.

The maintenance unit 60 is additionally provided with the inert gas supply system 52 similar to the first embodiment.

Next, FIGS. 2 and 3 will be referenced to describe the operations during an abnormal stop of the fuel cell system 1 according to the second embodiment. In the following description, the first line in FIG. 2 is taken to be the fuel supply system 61 and the water supply system 63, and the second line is taken to be the inert gas supply system 52. The operations and function of the solenoid valve 46 are similar to the first embodiment, and therefore a description is omitted.

If the supply of power to the control unit 40 stops, the supply of the fuel gas and the water by the fuel supply system 61 and the water supply system 63 acting as the first line is initiated in the maintenance unit 60 through the detection unit 45. The supply causes reforming into a reduction gas in the reforming unit 64 as described above, and the supply of the nitrogen gas in the inert gas supply system 52 acting as the second line is also initiated, and consequently a reduction gas of a predetermined concentration is supplied to the anode gas flow channel 11. With this arrangement, the fuel electrode (anode) in the SOFC 10 can be kept in a reduced state, and degradation caused by the oxidation reaction of the fuel electrode can be prevented.

When the SOFC 10 falls to the temperature T1, the supply of the fuel gas and the water from the fuel supply system 61 and the water supply system 63 (first line) is stopped. At this timing, the supply of the nitrogen gas from the inert gas supply system 52 (second line) is still ongoing, and the nitrogen gas can be used to perform an inert gas purge of the reduction gas at the fuel electrode. Thereafter, at the timing when the temperature of the SOFC 10 falls to reach a predetermined temperature T2 and the inert gas purge at the fuel electrode is completed, the supply of the nitrogen gas from the inert gas supply system 52 is stopped. With the above, the operations after an abnormal stop of the control unit 40 are completed.

In the second embodiment, operations different from the operations during the abnormal stop described above can be performed. In the different operations, the first line in FIG. 2 is taken to be the fuel supply system 61 and the second line is taken to be the water supply system 63.

If the supply of power to the control unit 40 stops, the supply of the fuel gas by the fuel supply system 61 acting as the first line and the supply of the water by the water supply system 63 acting as the second line are initiated in the maintenance unit 50. Through the supply, steam is generated in the evaporator 62, the fuel gas is reformed into a reduction gas in the reforming unit 64, and a reduction gas of a predetermined concentration is supplied to the anode gas flow channel 11. With this arrangement, the fuel electrode in the SOFC 10 is kept in a reduced state.

When the SOFC 10 falls to the temperature T1, the supply of the fuel gas from the fuel supply system 61 (first line) is stopped. At this timing, the supply of the water (steam) from the water supply system 63 (second line) is still ongoing, and the steam can be used to perform a steam purge at the fuel electrode. Thereafter, at the timing when the temperature of the SOFC 10 falls to reach the predetermined temperature T2 and the steam purge at the fuel electrode is completed, the supply of the water from the water supply system 63 is stopped, and the operations after an abnormal stop of the control unit 40 are completed. Additionally, the present embodiment may also include the inert gas supply system 52, and if the supply of power to the control unit 40 stops, the supply of an inert gas from the inert gas supply system 52 may be initiated and remain ongoing even after the completion of the steam purge, and after an inert gas purge is completed, the supply of the inert gas may be stopped and the operations after an abnormal stop of the control unit 40 may be completed.

As above, in the above fuel cell system 1 according to the second embodiment, the fuel electrode in the SOFC 10 can be kept in a reduced state to prevent oxidation degradation of the fuel electrode, similarly to the first embodiment. In addition, it is not necessary to provide components such as a hydrogen gas cylinder for supplying the hydrogen gas, and consequently the equipment costs can be reduced.

Furthermore, in the case where the reforming unit 64 is provided inside the SOFC 10, the SOFC 10 can be cooled by the endothermic reaction of reforming the fuel gas from the fuel supply system 61, and thereby also prevent oxidation degradation of the fuel electrode.

### Third Embodiment

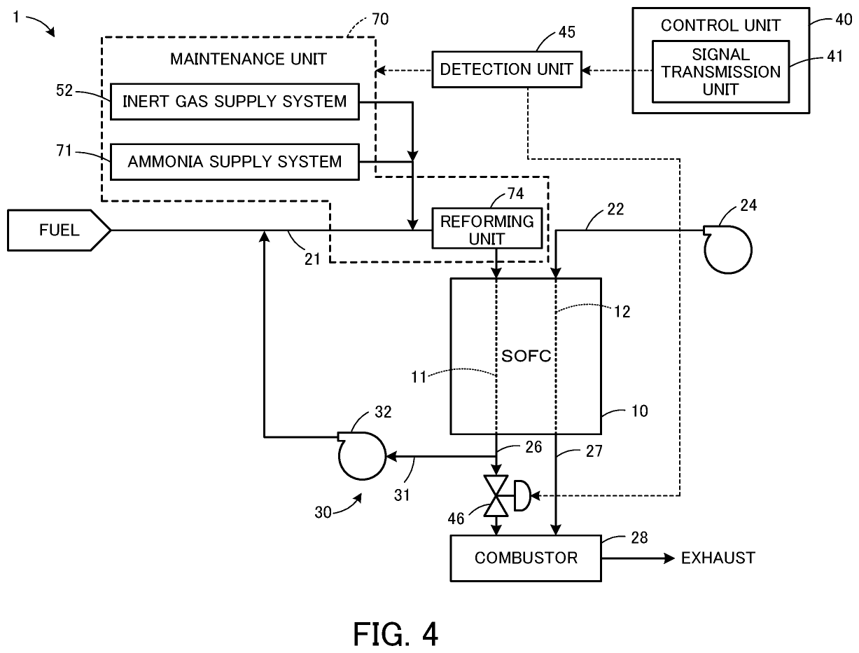

Next, a second embodiment of the present invention will be described with reference to FIG. 4. FIG. 4 is a block diagram illustrating a fuel cell system according to the third embodiment. As illustrated in FIG. 4, in the third embodiment, the configuration of a maintenance unit 70 is changed with respect to the first embodiment.

The maintenance unit 70 according to the third embodiment is provided with an ammonia supply system 71 that supplies aqueous ammonia to the anode gas supply channel 21. For example, the ammonia supply system 71 may include a tank storing aqueous ammonia as a supply source. The ammonia supply system 71 is provided with a solenoid valve for allowing or stopping the supply of the fuel gas in the supply channel, and the solenoid valve works similarly to the solenoid valve in the hydrogen supply system 51 described above. Also, the ammonia supply system 71 includes an aqueous ammonia evaporation unit (not illustrated) that vaporizes the ammonia in the aqueous ammonia while also evaporating the water for reforming.

The maintenance unit 70 is additionally provided with a reforming unit 74 provided in the anode gas supply channel 21. The reforming unit 74 has a function of reforming the aqueous ammonia and steam supplied from the ammonia supply system 71 into hydrogen gas (reduction gas) and nitrogen gas (inert gas). The reforming unit 74 supplies the hydrogen gas and the nitrogen gas to the fuel electrode through the anode gas flow channel 11. Although the diagram illustrates the case where the reforming unit 74 is provided in the anode gas supply channel 21, the reforming unit 74 may also be provided inside the SOFC 10.

The maintenance unit 70 is additionally provided with the inert gas supply system 52 similar to the first embodiment.

Next, FIGS. 2 and 4 will be referenced to describe the operations during an abnormal stop of the fuel cell system 1 according to the third embodiment. In the following description, the first line in FIG. 2 is taken to be the ammonia supply system 71 and the second line is taken to be the inert gas supply system 52. The operations and function of the solenoid valve 46 are similar to the first embodiment, and therefore a description is omitted.

If the supply of power to the control unit 40 stops, the supply of the aqueous ammonia and the steam by the ammonia supply system 71 acting as the first line is initiated in the maintenance unit 70 through the detection unit 45. The supply causes reforming into the hydrogen gas (reduction gas) and the nitrogen gas (inert gas) in the reforming unit 74 as described above, and the supply of the nitrogen gas in the inert gas supply system 52 acting as the second line is also initiated, and consequently a hydrogen gas of a predetermined concentration is supplied to the anode gas flow channel 11. With this arrangement, the fuel electrode (anode) in the SOFC 10 can be kept in a reduced state, and degradation caused by the oxidation reaction of the fuel electrode can be prevented.

When the SOFC 10 falls to the temperature T1, the supply of the aqueous ammonia and the steam from the ammonia supply system 71 (first line) is stopped. At this timing, the supply of the nitrogen gas from the inert gas supply system 52 (second line) is still ongoing, and the nitrogen gas can be used to perform an inert gas purge at the fuel electrode. Thereafter, at the timing when the temperature of the SOFC 10 falls to reach a predetermined temperature T2 and the inert gas purge at the fuel electrode is completed, the supply of the nitrogen gas from the inert gas supply system 52 is stopped. With the above, the operations after an abnormal stop of the control unit 40 are completed.

Note that the third embodiment may also be configured such that the inert gas supply system 52 (second line) is omitted and the nitrogen gas is not supplied as part of the above operations when an abnormal stop occurs.

As above, in the above fuel cell system 1 according to the third embodiment, the fuel electrode in the SOFC 10 can be kept in a reduced state to prevent oxidation degradation of the fuel electrode, similarly to the first embodiment. In addition, it is not necessary to provide components such as a gas cylinder for supplying the hydrogen gas or the fuel gas, and consequently a space savings can be attained with the equipment.

Although the above embodiments are provided with the recirculation channel 31, the recirculation channel 31 may also be omitted, and the exhaust gas from the anode gas discharge channel 26 may also be discharged to the combustor 28. Also, although the recirculation channel 31 is described as acting like a heat source, a high-temperature part in a location different from the recirculation channel 31 inside the fuel cell system 1 may also be used as a heat source.

In addition, embodiments of the present invention have been described, but the above embodiments may also be combined in full or in part and treated as another embodiment of the present invention.

Also, embodiments of the present invention are not limited to the embodiments described above, and various modifications, substitutions, and alterations are possible without departing from the scope of the technical idea according to the present invention. Further, if the technical idea according to the present invention can be achieved according to another method through the advancement of the technology or another derivative technology, the technical idea may be implemented using the method. Consequently, the claims cover all embodiments which may be included in the scope of the technical idea according to the present invention.

### INDUSTRIAL APPLICABILITY

The fuel cell system according to the present invention is suitable for application to fuel cell systems for domestic use, commercial use, and all other industrial fields.

This application is based on Japanese Patent Application No. 2019-234464 filed on Dec. 25, 2019, the content of which is hereby incorporated in entirety.

What is claimed is:

1. A fuel cell system, comprising:
a solid oxide fuel cell including
a fuel electrode supplied with a reduction gas,
an air electrode supplied with an oxidant gas, and
an electrolyte interposed between the oxide electrode and the air electrode, the solid oxide fuel cell generating electricity through an electrochemical reaction between the reduction gas and the oxidant gas;
a control unit that respectively controls amounts of the reduction gas and the oxidant gas supplied to the solid oxide fuel cell and outputs a normal signal and/or an abnormal signal;
a detection unit that detects an abnormal state of the control unit by receiving the normal signal and/or the abnormal signal from the control unit; and
a maintenance unit that maintains the fuel electrode in a reduced state upon the detection unit detecting the abnormal state of the control unit.

2. The fuel cell system according to claim 1, wherein the maintenance unit includes a hydrogen supply system that supplies hydrogen to the fuel electrode as the reduction gas.

3. The fuel cell system according to claim 1, wherein the maintenance unit includes
a fuel supply system that supplies a hydrocarbon-based fuel,
a water supply system that supplies water, and
a reforming unit that reforms the hydrocarbon-based fuel supplied from the fuel supply system using the water supplied from the water supply system to generate reformed gas and supplies the reformed gas as the reduction gas to the fuel electrode.

4. The fuel cell system according to claim 1, wherein the maintenance unit includes an ammonia supply system for supplying the reduction gas to the fuel electrode.

5. The fuel cell system according to claim 1, further comprising:
an inert gas supply system that supplies an inert gas to the fuel electrode to maintain the fuel electrode in the reduced state upon the detecting unit detecting the abnormal state of the control unit.

6. The fuel cell system according to claim 1, wherein the maintenance unit includes
a supply channel that supplies the reduction gas to the fuel electrode, and
a recirculation system that recirculates exhaust gas discharged from the solid oxide fuel cell into the supply channel, thereby to recirculate the reduction gas from the recirculation system to the fuel electrode through the supply channel.

7. The fuel cell system according to claim 1, further comprising:
a discharge channel for discharging an exhaust gas from the fuel electrode to outside the system; and
a valve that opens the discharge channel to discharge the exhaust gas, wherein
the valve closes in response to the detection unit detecting stopping of the normal signal and/or receiving of the abnormal signal.

8. A fuel cell system, comprising:
a solid oxide fuel cell including
a fuel electrode supplied with a reduction gas,
an air electrode supplied with an oxidant gas, and
an electrolyte interposed between the oxide electrode and the air electrode, the solid oxide fuel cell generating electricity through an electrochemical reaction between the reduction gas and the oxidant gas;
a computing device; and
a storage medium containing program instructions stored therein, execution of which by the computing device causes the fuel cell system to provide the functions of:
a control unit configured to respectively control amounts of the reduction gas and the oxidant gas supplied to the solid oxide fuel cell and output a normal signal and/or an abnormal signal;
a detection unit configured to detect an abnormal state of the fuel cell system by receiving the normal signal from the control unit, and/or by receiving the abnormal signal from the control unit; and
a maintenance unit configured to maintain the fuel electrode in a reduced state upon the detection unit detecting the abnormal state of the fuel cell system.
